(19) United States
(12) Patent Application Publication
(10) Pub. No.: US 2008/0301873 A1
(43) Pub. Date: Dec. 11, 2008

(54) Patient Positioning apparatus

(76) Inventors: Elizabeth A. White, American Fork, UT (US); Joshua Robert Oldham, Humble, TX (US)

Correspondence Address: SAND & SEBOLT, AEGIS TOWER, SUITE 1100, 4940 MUNSON STREET, NW, CANTON, OH, 44718-3615, US

(21) Appl. No.: 12/075,000

(22) Filed: Mar. 7, 2008

Related U.S. Application Data
(63) Continuation-in-part of application No. 11/403,112, filed on Apr. 12, 2006.
Application No. 11/403,112 is a continuation-in-part of application No. 11/170,605, filed on Jun. 29, 2005, now Pat. No. 7,434,278.

(51) Int. Cl. A61G 7/14

(52) U.S. Cl. 5/85.1

(57) ABSTRACT

Several embodiments of a patient positioning apparatus are disclosed, each configured for repositioning a patient on a bed. The apparatus includes a support frame which may be positioned over an adjustable bed so that the straps extend downwardly from the frame and secure to a patient support such as a support sheet so that a patient can be partially or totally suspended when the bed is lowered.

### CROSS REFERENCE TO RELATED APPLICATIONS

This application is a continuation in part of application Ser. No. 11/403,112, filed on Apr. 12, 2006; which is a continuation in part of application Ser. No. 11/170,605, filed Jun. 29, 2005, the disclosures of which are incorporated herein by reference.

### BACKGROUND OF THE INVENTION

1. Technical Field

The present invention relates to an apparatus for assisting a caregiver when transferring, rotating, or otherwise repositioning a bedridden person. More particularly, the present invention relates to a unit which may be collapsible and is configured for repositioning a bedridden patient by utilizing existing lift technology on a hospital bed to create suspension or patient movement.

2. Background Information

Immobility of a patient contributes greatly to the deterioration of patient health. Immobile patients are prone to bedsores and pneumonia. A bed sore can take months or years to heal depending on the severity and location of the sore. Pneumonia occurs in immobile patients because secretions pool in the lungs, fostering bacterial growth. Generally side-to-side turns of such patients, approximately every two hours can prevent many occurrences of bedsores and pneumonia. Additionally, side-to-side turns are necessary to accomplish examinations of the patient. However, turns of this nature are generally the responsibility of hospital nurses, orderlies, or other staff in similar types of facilities.

Additionally, patients require the head of the bed to be raised to facilitate breathing and increase comfort. As a result of this incline, patients tend to slide toward the foot of the bed, impeding a patient's normal breathing and digestive functions and resulting in patient discomfort.

When a patient is obese or larger than the staff member, the force required to properly reposition the patient is considerable. Consequently, multiple staff members are required to reposition the patient manually. Moreover, if additional staff members are unavailable, the lone staff member is susceptible to injuries while attempting to transfer or reposition the patient without either mechanical assistance or additional staff labor.

Back injury is a common work injury of nurses and hospital staff generally as a result of moving overweight patients or patients who are significantly larger than the staff member. The act of turning a patient from side to side precludes proper body mechanics for lifting. In addition, obesity in the United States is increasing in marked amounts. Patient weight increases will only exacerbate the rate of back injuries among nurses, and increase the number of workers compensation claims filed as a result of such injuries as well as reduce the number of able body hospital staff. Consequently, assistance is necessarily required to accomplish necessary patient movement as well as to protect hospital staff members against injury proximately resulting from patient repositioning, turning and transference.

Moreover, the task of patient repositioning is labor intensive and time consuming. Generally, patient movement requires at least two staff members. Generally, nurses are female and significantly smaller in stature and weight than the patients they are assigned to care for. Furthermore, hospitals and skilled nursing facilities are homes to patients weighing in excess of 250 pounds. Consequently, at least three staff members are sometimes required to reposition a patient of this size. With the increase of nursing and staffing short-ages, it is frequently impossible to gather enough staff members to move a large or oversized patient. Thus, either patient care suffers or the risk of injury to staff members is greatly increased.

Another problem is money. Devices that incorporate machines, motors, and other complicated machinations to effectuate lift and other movement cost much more money than those that don't as well as incur more potential for civil liability should one of those machinations fail. Further, existing devices do not have a simple and effective means of gripping fabric, draw sheets, or standard hospital bed linens on which a patient is lying. Typically, devices such as that found in U.S. Pat. No. 5,890,238 to Votel are meant for patient transfer only and because of the gripping design are not easy for a caregiver to attach to linens.

Therefore a need exists for a functional, yet simple to operate, patient repositioning apparatus. Such an apparatus should be operational by one staff member without compromising patient safety and staff member safety; easy to install and operate as well as not consume scarce space in hospital or skilled nursing facility; must not compromise patient safety when effectuating the tasks of patient repositioning; can be used by a single caregiver to reposition a patient; is capable of easy attachment to linens for suspension of a person; and does not require expensive internal machinations to accomplish patient lift but uses existing lift technology on beds to accomplish suspension or movement of a patient.

### BRIEF SUMMARY OF THE INVENTION

Accordingly, one object of the present invention is to provide an apparatus capable of being operated by one person to reposition a patient longitudinally in a bed, reposition a patient laterally within the bed, turning a patient on their side, or lifting a patient.

A second object of the invention is an apparatus that easily integrates with standard hospital beds during usage.

A third object of the invention is to provide an apparatus which repositions a patient without injuring either the patient or staff member.

A fourth object of the invention is to provide an apparatus that does not consume precious space in skilled care facilities, hospitals or patient homes, and is easily stored when not in service.

A fifth object of the invention is to provide an apparatus which is inexpensive to produce and thus easily purchased by medical care facilities and family members faced with caring for immobile loved-ones in their home.

A sixth object of the invention is to reposition a patient to facilitate normal respiratory and digestive function.

A seventh object of the invention is to reduce patient feelings of patient isolation because the apparatus is less obtrusive than the prior art.

An eighth object of the present invention is to provide a repositioning apparatus that is able to use the lift of a hospital bed to reposition a patient Through suspension when the bed is lowered.

A ninth object of the present invention is to provide a simple attachment device that will easily secure to linens.

### BRIEF DESCRIPTION OF THE DRAWINGS

FIG. 1 is an elevated perspective view of a patient positioning apparatus with positioning arms in an extended position.

FIG. 2 is an elevated perspective view of a patient positioning apparatus with positioning arms in a retracted position.

FIG. 3 is an elevated perspective view of a patient positioning apparatus positioned over a standard hospital bed with adjustable straps secured to a support sheet.

FIG. 4 is an elevated perspective view of a patient positioning apparatus positioned over a standard hospital bed with two adjustable straps secured to a support sheet and moving a person lying on the support sheet a quarter turn.

FIG. 5 is a side view of a patient positioning apparatus positioned over a standard hospital bed with adjustable straps secured to a support sheet and suspending a person lying on the support sheet.

FIG. 6 is an elevated perspective view of the baseless patient positioning apparatus secured to a wall and positioned over a hospital bed.

FIG. 6a is an elevated perspective view of a baseless patient positioning apparatus secured to a wall.

FIG. 7 is an elevated perspective view of a ceiling mounted embodiment of a patient positioning apparatus.

FIG. 8 shows a hook and rod arrangement fastened to a support sheet.

FIG. 8a shows a detailed view of the hook and rod arrangement fastened to the support sheet.

FIG. 9 is an exploded perspective view of the patient positioning apparatus with retractable positioning arms.

FIG. 10 is an elevated front perspective view of a fabric gripper incorporating interlocking serrated teeth for gripping fabric in a closed and locked position.

FIG. 10a is an elevated front perspective view of a fabric gripper in a closed and unlocked position with wedges visible.

FIG. 11 is an elevated rear perspective view of the fabric gripper in the closed and locked position.

FIG. 12 is a side view of the fabric gripper.

FIG. 13 is an elevated front perspective view of the fabric gripper in an open position.

FIG. 14 is an elevated rear perspective view of the fabric gripper in the open position.

FIG. 15 is a side view of a closed fabric gripper utilizing a toggle clamp.

FIG. 16 is a side elevational view of a ceiling mounted embodiment of the repositioning apparatus of the present dimension.

FIG. 17 is an end elevational view of the ceiling mounted embodiment.

FIG. 18 is a sectional view taken on line 18-18 of FIG. 17.

FIG. 19 is a end elevational view of the ceiling mounted embodiment showing an initial stage of transferring a patient from one bed to another.

FIG. 20 is similar to FIG. 19 shows a subsequent stage of the transference in which the bed on which the patient was lying is lowered so that the patient is suspended above the bed.

FIG. 21 similar to FIG. 20 and shows the patient having moved from a position above the first bed to a position above the second bed.

FIG. 22 is similar to FIG. 21 and shows the second bed having been arranged to support the patient.

FIG. 23 is an operational view showing the patient lying on the bed atop a sheet with the sheet support beneath the sheet.

FIG. 24 is similar to FIG. 23 and shows the straps on the left side secured to the sheet support.

FIG. 25 is similar to FIG. 24 and shows the bed being lowered to roll the patient the right.

FIG. 26 is similar to FIG. 25 and shows the straps on the left side having been uncoupled from the sheet support and the straps on the right side coupled to the sheet support.

FIG. 27 shows a further stage in which the bed has been lowered to roll the patient onto his or her back.

FIG. 28 shows the straps on the right side uncoupled from the sheet support.

FIG. 29 shows a further stage of operation in which the bed is lowered to roll the patient onto his or her left side.

FIG. 30 is a further stage of operation showing the straps on the right side uncoupled from the sheet support so that the soiled sheet may be removed and a clean sheet may be spread onto the mattress.

Similar numbers refer to similar parts throughout the drawings.

### DETAILED DESCRIPTION OF THE INVENTION

A complete understanding of this invention can be gained through reference to the drawings in conjunction with a thorough review of the disclosure herein. To facilitate this understanding, a table of commonly used reference numerals is provided.

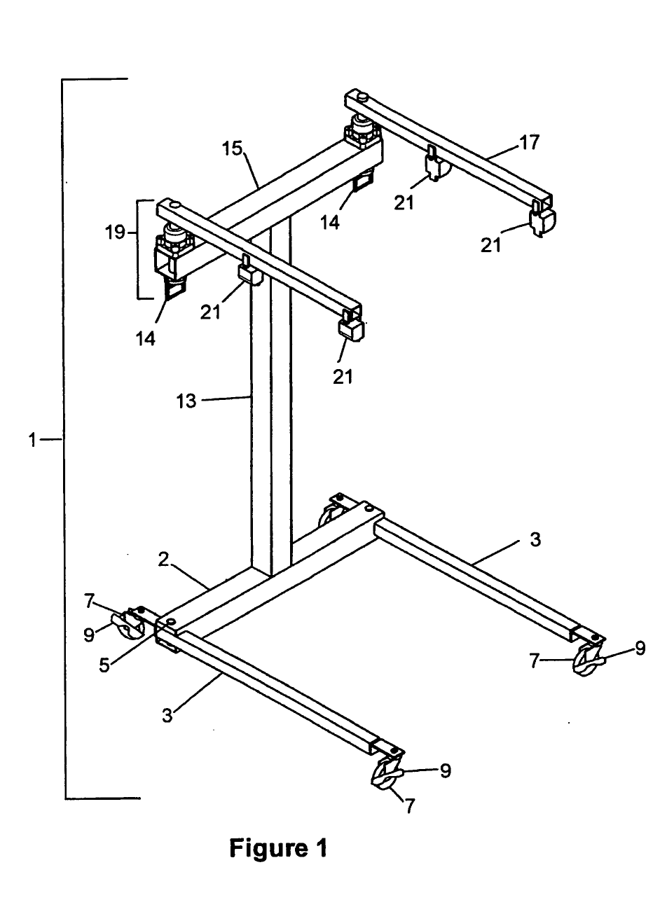

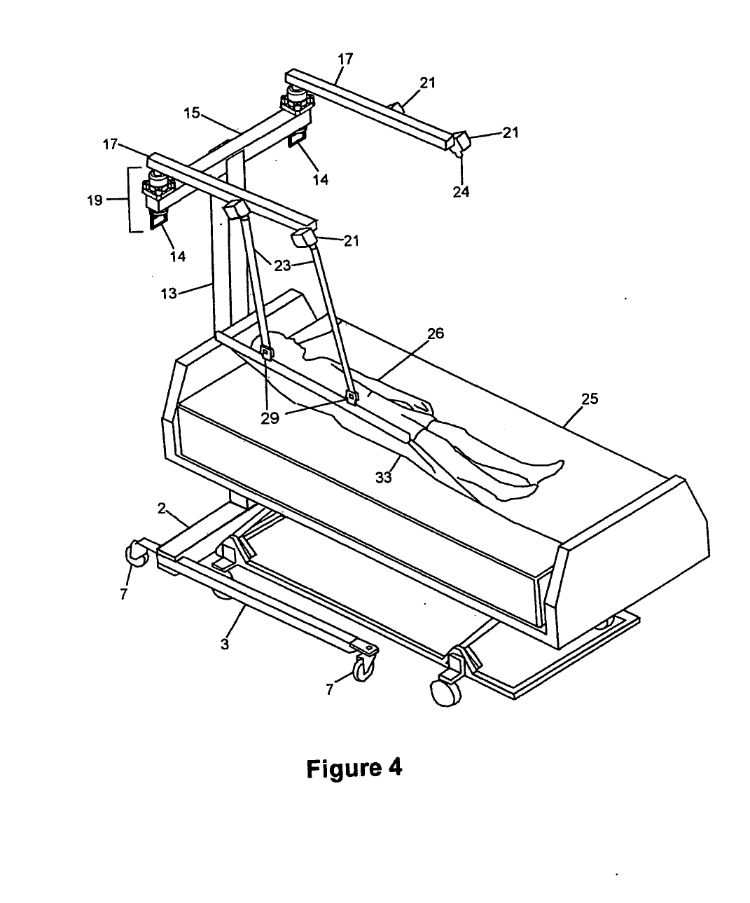

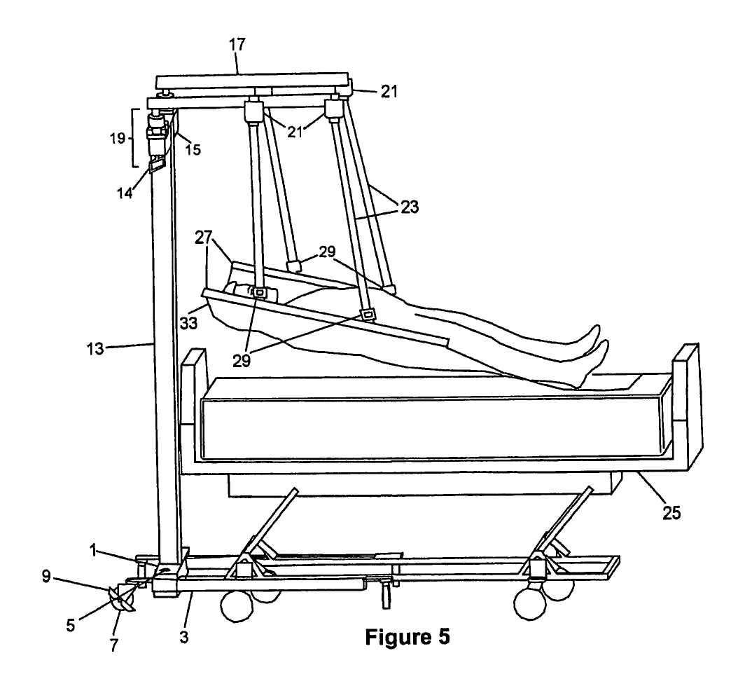

FIG. 1 is illustrative of one embodiment of the patient repositioning apparatus 1 for repositioning a person in a standard hospital bed. As used herein, the terms suspended or suspend also include partially suspended or partially suspend where the bed or some other member also assists in supporting the patient. Positioning apparatus 1 is composed of a moveable base with wheels 7; a vertical support column 13; and having one or more positioning arms 17 on the top of device 1. Retractable belt assemblies include a retraction mechanism 21 each with a housing for containing straps 23 which may extend downward and secure to a patient support sheet 33. (Shown in FIGS. 3 & 4) As shown in FIGS. 3 and 4, a patient 26 on a bed can be repositioned by using the vertical movement of a standard hospital bed 25. (e.g., electrical, crank actuated, other mechanical motion, etc) Bed 25 is raised upward towards the positioning arms 17 thereby giving slack to gripping straps 23 with retractable belt assembly 21 on the arms 17. Once there is slack in the straps 23, a connection member such as a buckle 24 on the ends of the straps can be inserted and locked into a buckle latch 29 or other connection member on a patient support sheet 33. Once the buckles 24 are locked, the bed 25 can be lowered and therefore a person is “lifted” by being suspended when the bed 25 is lowered, whereby sheet 33 creates a sling.

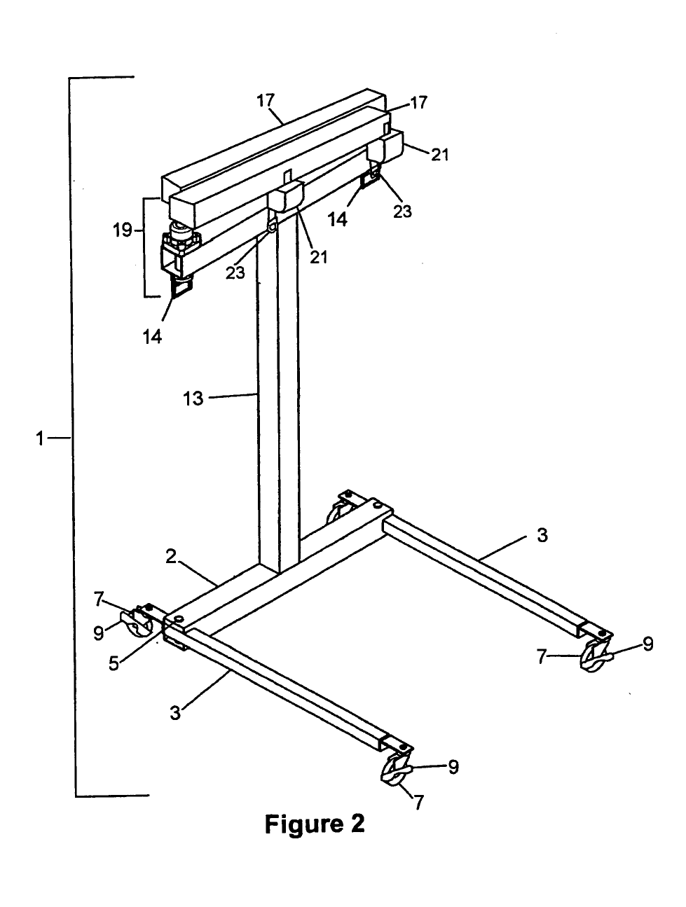

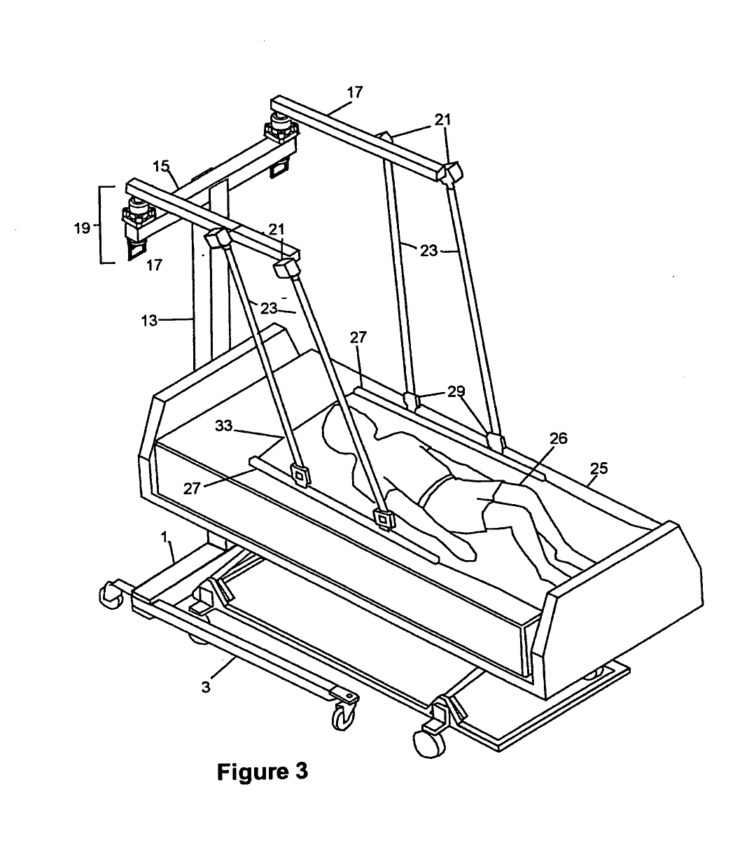

An exemplary embodiment of a base portion incorporates one or more legs 3 capable of extending in opposite directions from either the anterior or posterior of the apparatus. Preferably, legs 3 telescope, as in FIGS. 1 and 2, thereby allowing them to extend under a bed or retract when the apparatus is not in use thus, minimizing the space necessary to store the apparatus and to account for size differences in beds. Some available means for forming a base with legs, wheels, swivels, and their various embodiments including locking and clamping mechanisms are described in related U.S. patent application Ser. No. 11/170,605 entitled “Patient Mobility Apparatus” of White, disclosed above. However, in an alternate embodiment, the base can be folded, or otherwise extended, collapsed, or legs locked for easy maneuverability and for providing sufficient stability.

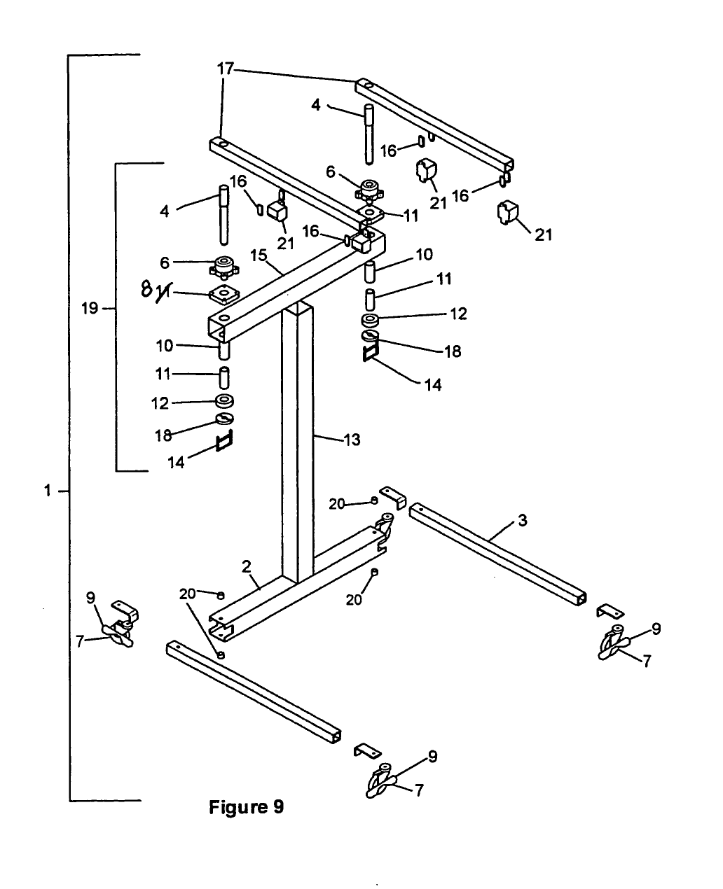

FIGS. 1 and 2 also show a support column 13 that coupled to base 2 using known means. In a preferred embodiment, a support column 13 is fixed and is capable of supporting a repositioning structure comprised of a horizontal support 15 having one or more positioning arms 17. The repositioning structure is typically fixed using known means such as common welding techniques or being inserted and fastened to a groove in the support column 13 as is shown in FIGS. 1 and 2 to the upper portion of the support column 13. However, the repositioning structure can also be fixed to any place on the support column 13 so long as it is capable of being positioned over a bedridden person for repositioning. Retractable belt assemblies 21 can be coupled to the positioning arms 17 using support tabs 16 (See FIG. 9) whereby a rivet (not shown) can be inserted through the tab and through a positioning arm 17. Equivalent methods in the art will be immediately recognizable for securing similar assemblies to metal structures such as those disclosed.

The support column 13 of the preferred embodiment is constructed of powder-coated steel and is about 4 inches square which has been proven to withstand the weight of a person 26—even those of substantial weight-suspended by arms 17. In an alternate exemplary embodiment, (not shown) an outer column of the support column can swivel around an inner column with apertures. The outer column support, also having apertures, is capable of aligning with those of the inner column by inserting the outer column over the inner column. In this way, the swivel can be locked by inserting a locking pin through each of the inner and outer column support apertures. Other known means for creating a swiveling column will be immediately recognized by those skilled in the art.

Most hospital beds are of a standard height. Because of the uniform height of beds, a fixed height support column 13 will prove to be an effective embodiment of the present invention. However, because some beds will vary in height and will vary in the levels of vertical movement, it is sometimes preferable to have an embodiment of the present invention that can also accommodate vertical movement.

To effectuate vertical movement for the present invention to account for the differences in bed sizes, a crank assembly or an hydraulic assembly described in related U.S. patent application Ser. No. 11/170,605 entitled “Patient Mobility Apparatus” of White disclosed above may be incorporated into the present invention.

The repositioning structure atop the support column 13 is used for repositioning patient 26 in a standard hospital bed 25. The position of the repositioning structure and its associated structures such as its arms 17 relative to the hospital bed 25 and the motor incorporated into the hospital bed 25 is used as the means for repositioning a patient 26. Standard hospital beds typically come with an electric motor or other adjustable beds used to raise, lower, or otherwise place the bed 25 in various positions. Taking advantage of this standard lifting technology relative to the present invention allows for one caregiver to easily reposition a patient 26 using the various embodiments of the present invention.

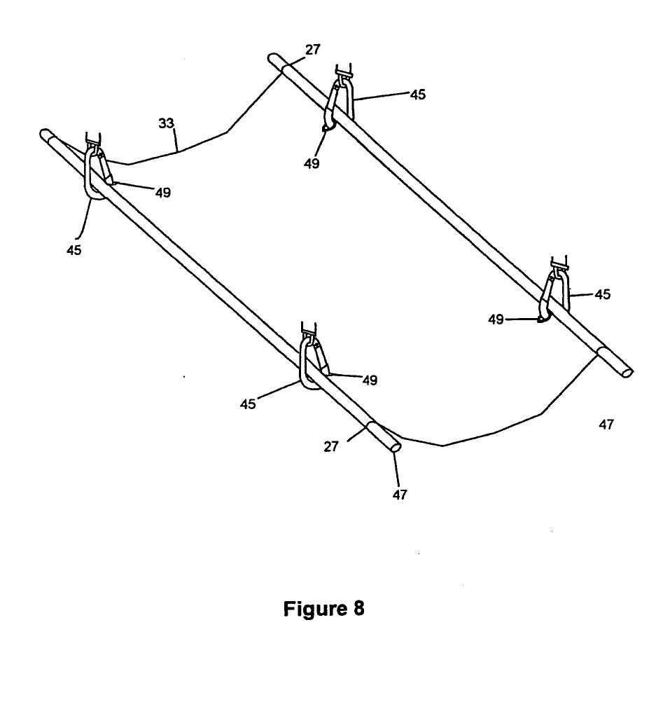

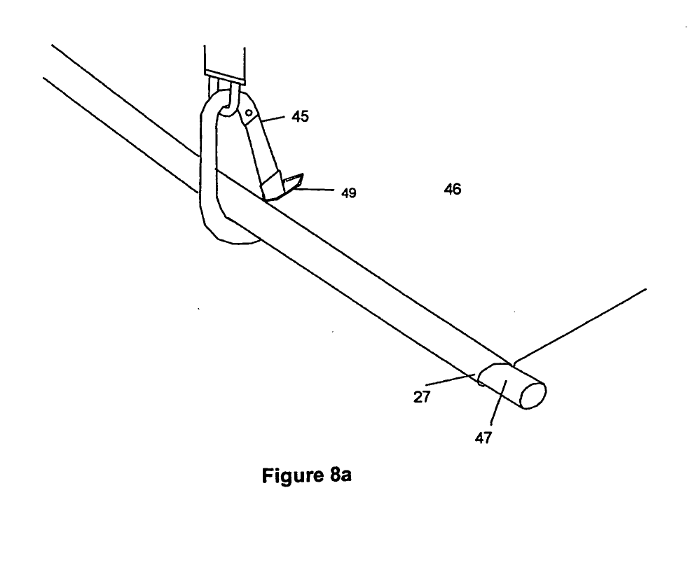

FIGS. 3 and 4 illustrate repositioning movement using a preferred embodiment of the present invention. In FIG. 3, a person 26 is laid flat on a patient support sheet 33 that has pockets 27 capable of receiving a rigid rod 47 (FIG. 8) and also having receiving buckles 29 for receiving and releasably connecting to buckle inserts 24. A caregiver then positions the bed to an appropriate distance below the arms 17 such that the straps 23 are slack and the buckle inserts 24 can be inserted into the receiving buckles 29. Once the buckle inserts 24 are inserted into the receiving buckles 29, a caregiver can either take out the slack in the straps 23 through adjustment of the straps 23 through automatic adjustment using known automatic retraction in the retractable belt assembly 21 or through manual adjustment methods. Any remaining slack can be taken out by lowering the bed and, once completely taken out, the patient 26 will be suspended on the support sheets 33. Once the patient 26 is suspended, a caregiver can change bed sheets or perform other various tasks related to caring for a patient.

For example, FIG. 4 demonstrates how one embodiment of the present invention can be used to turn a patient a quarter turn by only inserting the buckle inserts 24 into the receiving buckles 29 on one side of a patient support sheet 33. In this way, once the bed is lowered so that slack is taken out of the straps 23, a patient can be partially turned from side to side.

To change patients' bed linens, a bottom support sheet 33 is placed underneath the bed linens. Bed 25 is then raised enough to allow for the insertion of buckle inserts 24 into receiving buckles 29 onto one side of support sheet 33. The bed linens are then loosened onto one side of the bed 25. By then lowering the bed 25, the person will roll to one side of the bed 25. The bed 25 is then raised and buckle inserts 24 are removed from receiving buckles 29 and support sheet 33 is spread back onto the bed mattress. Once the dirty bed linens are rolled next to the patient 26 the clean linen is spread on one side of the mattress and the other half is rolled or otherwise bunched up next to the patient 26. On the other side of bed 25, the dirty linen is loosened and buckle inserts 24 are attached within receiving buckles 29 on that side of the support sheet 33. The bed 25 is then lowered whereby the patient 26 rolls onto the clean linen. The bed is then raised and the buckle inserts are removed from the support sheet 33. Therefore, the dirty linen may be removed and the clean linen can be pulled out from underneath the patient 26 and spread uniformly over the mattress.

In their simplest form, the arms 17 of the present invention used for lifting and repositioning remain fixed and extend outward of the support column 13, thereby allowing them to be positioned over a patient 26 in a bed 25. This will allow the utility of the present invention to be realized since it can easily be moved around to any position over a bed 25. This is especially so if there is a base that incorporates locking wheels 7 with telescoping or otherwise adjustable legs.

In a preferred embodiment, shown in FIG. 1 and in an exploded view in FIG. 9, arms 17 are joined to a horizontal support 15 through locking arm pivots 19 that allow the arms 17 to extend outward when in use and to retract inward toward the support column 13 when not in use. The pivot pin arrangement incorporates pivot shafts 4 placed inside a flange bearing 6 and bearing extension plate 8 allowing the shaft 4 to rotate. The shaft 4, bearing 6, and extension plate 8 are then situated over an aperture formed in top and bottom walls of the arm 17. On the bottom of the arm 17 is a hole stiffener 10 and sleeve 11 into which the shaft 4 can be inserted and around which are inserted a top 12 and bottom 18 washer and spring loaded handle 14 capable of engaging and disengaging the washers 12 and 18, thereby allowing the arms 17 to rotate. When the handle is released, the washers 12 and 18, will engage to lock the arm 17 in place. Alternatively, a simple pivot mechanism would also work. The advantage of the washer assembly is that it allows both arms to retract and extend at an equal height.

Although the above-described embodiment is the preferred method for extending and retracting arms, there are other exemplary assemblies known in the art that can also provide movement acceptable for purposes of achieving the objects of the present invention.

Once an arm 17 is positioned over a patient 26, it is secured to a support sheet 33 through the preferred use of a buckle assembly and capable of supporting a patient 26. Because patients can oftentimes be overweight, retractable straps with buckles using heavy duty nylon or canvas or other similar materials can be used to account for extra weight. Acceptable retractable devices can be found in standard off-the-shelf seat belt units incorporating heavy duty nylon webbing capable of supporting a person suspended by the arms 17. McMaster-Carr retractable assemblies have been found to meet acceptable standards of load to lift ratios. Seat belts of this type with release buttons on the buckle inserts similar to those used in automobiles and which can withstand inertial unlatching are common. (See, for example, U.S. Pat. No. 6,725,509 to Lee and its related references) Further, the receiving mechanism for the buckles can be attached to the support sheet, a gripper or other mechanism secured to the support sheet or in other embodiments those skilled in the art will immediately appreciate.

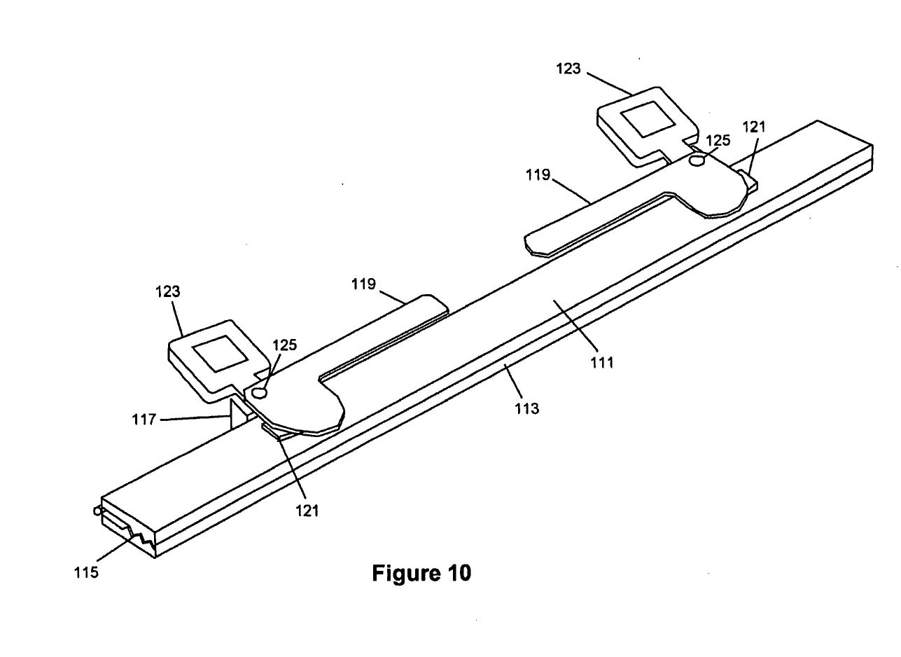

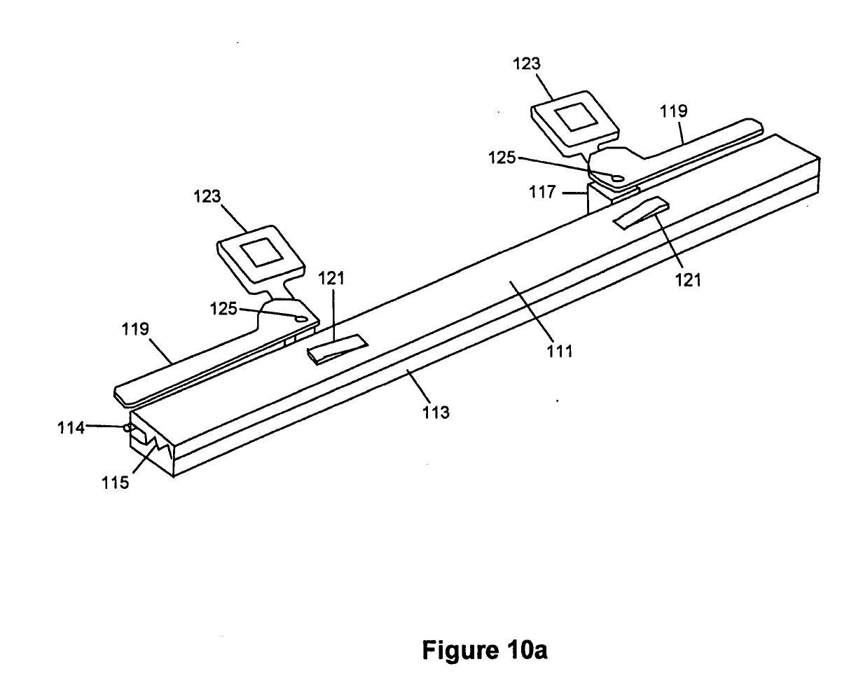

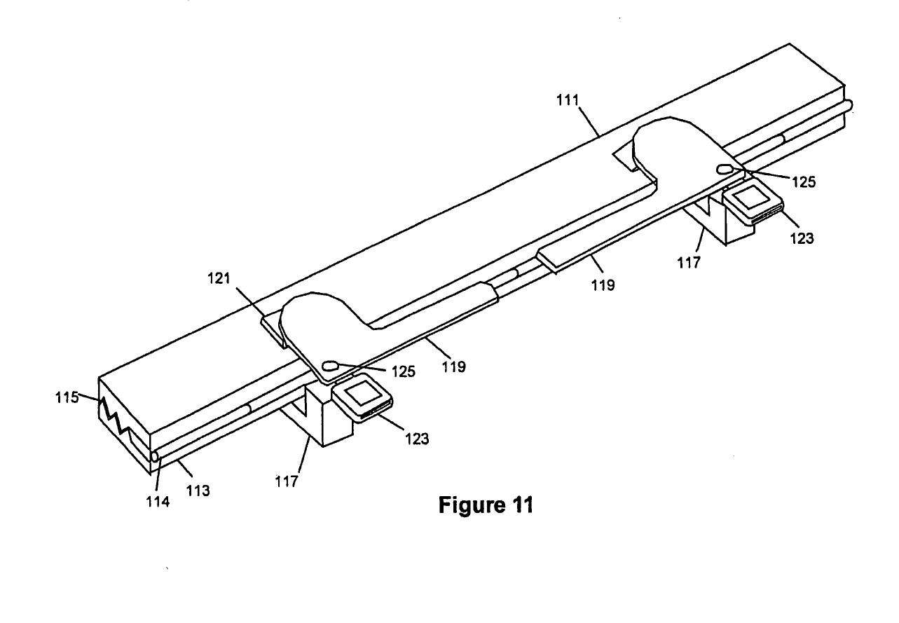

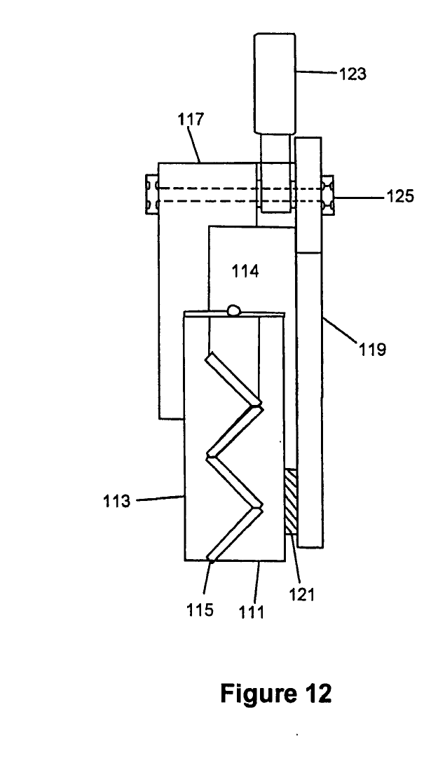

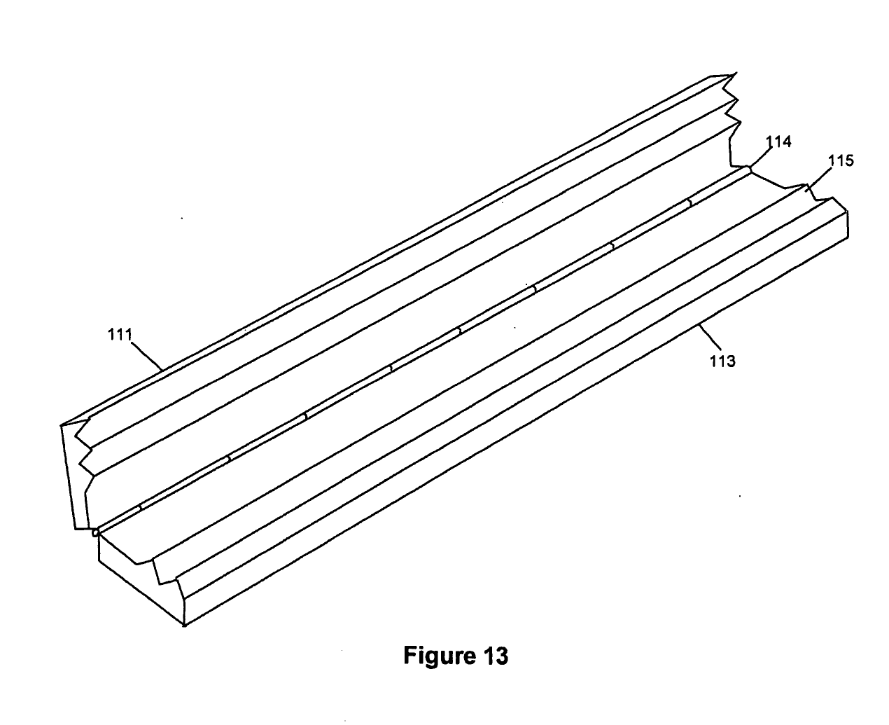

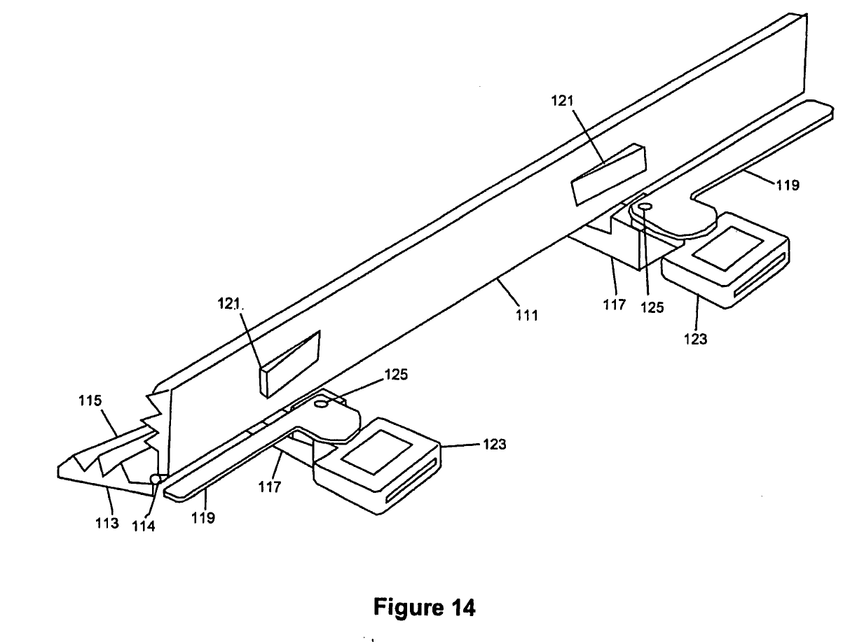

A preferred embodiment for securing to a support sheet is to use a detachable fabric gripper as is shown in FIGS. 10-14 that may be attached to linens found in hospitals and other patient care facilities. A fabric gripper is comprised of an upper bar 111 and lower bar 113 which are hinged 114 along an edge joining the upper 111 and lower 113 bars. On the inside of each bar 111 and 113 that contacts the other are interlocking serrated teeth 115 used to securely grab fabric. It is preferred that the teeth 115 are lined with a non-slip material, such as rubber or other similar coating to prevent linen slippage. In another exemplary embodiment, non-serrated bars also have been shown to be effective and will generally support patients in excess of 200 lbs. FIGS. 10, 11 and 12 show the fabric gripper in a closed and locked position while FIG. 10a shows the gripper in a closed and unlocked position and FIGS. 13 and 14 shows the fabric gripper in an open position.

Bottom bar 113 has a clamp support 117, which attaches to the lower bar 113, and then extends towards the top bar 111, where it provides support for a receiving buckle 29 and a clamp handle 119. The handle 119 pivots on a pivot pin 125 that pivotally mounts it to the clamp support 117 and the receiving buckle 29. When the gripper is closed and locked (FIG. 10), the handle 119 extends over the top bar and engages a wedge 121, thereby sealing or clamping the bars 111 and 113 together. Wedges 121 on the bars (beneath the handle flanges) ensure a tight grip when the handle is closed. A slick material on the wedge 121 (e.g., Teflon) can be used to facilitate the closing of the handle 119. Preferably, the handle 119 is long enough to provide sufficient leverage to wedge the bars 111 and 113 closed.

Receiving buckles 29 are mounted on the pivot pins 125 which support the handles 119 on clamp supports 117. Buckles 29 are similar to seat belt latches as described above, to receive buckle inserts 24 at the end of the retractable straps 23 on a patient mobility apparatus 1. In use, a caregiver would fold a draw sheet of a hospital bed to a desired position. A fabric gripper would be placed open on a bed next to the fold of the draw sheet. The fold of fabric is then tucked into the gripper, which is then closed. The handles 119 are then moved to the engaging or closed position against the wedge 121 to firmly grip the fabric in place.

A handle 119 and wedge 121 arrangement is a simple, cost-effective gripping assembly although other arrangements can be used (e.g., spring biased mechanisms, manually locking mechanisms, toggle clamps, and etc.). For example, using the same bar arrangement as described above, toggle clamps can be used to allow for hinging, opening, closing, and locking the bars securely shut after a fabric sheet is placed between the two bars.

As an alternative embodiment, straps of any durable material can be fixed, permanent or removable, to either the retractable belts 21 or the receiving buckles 29 that incorporate a traditional belt and buckle arrangement. Using this arrangement, straps 23 can be cinched to a desired length and tension. When not in use, they can be placed to the side of the bed. Furthermore, attachments to the patient support sheet need not be flexible straps but may also be of a more rigid construction.

Support sheets 33 are preferred for the present invention to provide a stable, lifting, flexible platform on which to lift patients. Exemplary support sheets 33 proven to be acceptable for supporting patients of varying weights can be made of known vinyl, nylon, canvas or other comparable materials. Further, harnesses, or other known suspension supports have also been shown to be effective when used in accordance with the designs of the present invention. In addition, normal weight hospital sheets have been shown to work without problems. Support sheets 33 can also incorporate buckles fastened to them using known means such as sewing heavy duty buckle ends to reinforced material and stitching onto the fabric 46. Other means for fastening buckles and other attachments to the fabric 46 will be immediately identifiable to those skilled in the art. FIGS. 8 and 8a shows a support sheet 33 commonly used in hospitals having pockets 27 along the sides capable of receiving a sturdy rod 47, as well as holes 49 that can be reinforced for inserting hooks such as carabiner hooks 45 secured to the end of the straps 23. Other hook arrangements will also be sufficient such as C-shaped or J-shaped hooks or other known hooks.

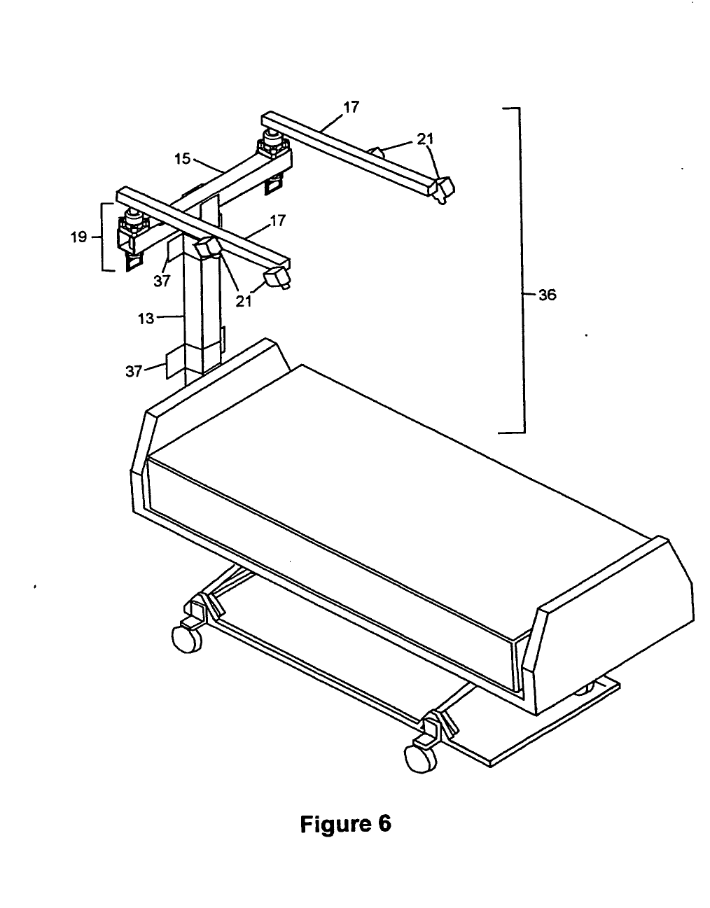

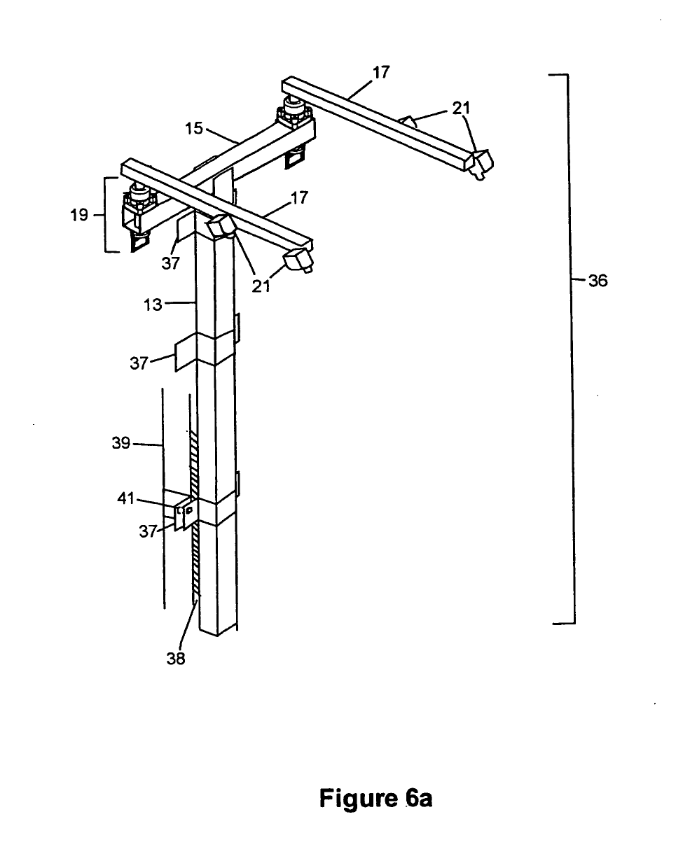

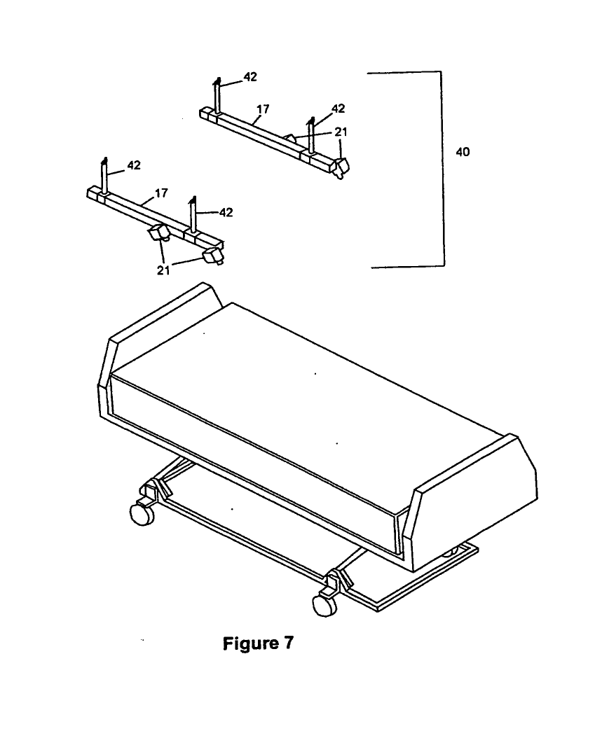

There are various ways in which the present invention can be mounted that will not sacrifice its utility or overall design. For example, FIGS. 6 and 6a illustrate a wall mounted device 36 that is secured to a wall through the use of one or more wall brackets 37. Typically, the brackets 37 are made from steel or other heavy duty metal secured to a wall 38. Brackets 37 are secured through heavy duty bolts 41 to studs 39 in a wall 38. Additionally, FIG. 7 illustrates an embodiment of the present invention 40 capable of being mounted to a ceiling through the use of one or more ceiling mounts 42. Standard mounting brackets in the art that can support the weight of a patient have proven to be effective. For example, brackets as in the wall mounted embodiment can be mounted to studs in the ceiling and incorporate known fastening means for securing the ceiling mounts 42. In this way, the overall shape of the present invention can be altered to accommodate various designs. For example, in a slight modification to the embodiments shown in the Figures, the support column of the body can be configured to account for varying bed widths and other spacing issues.

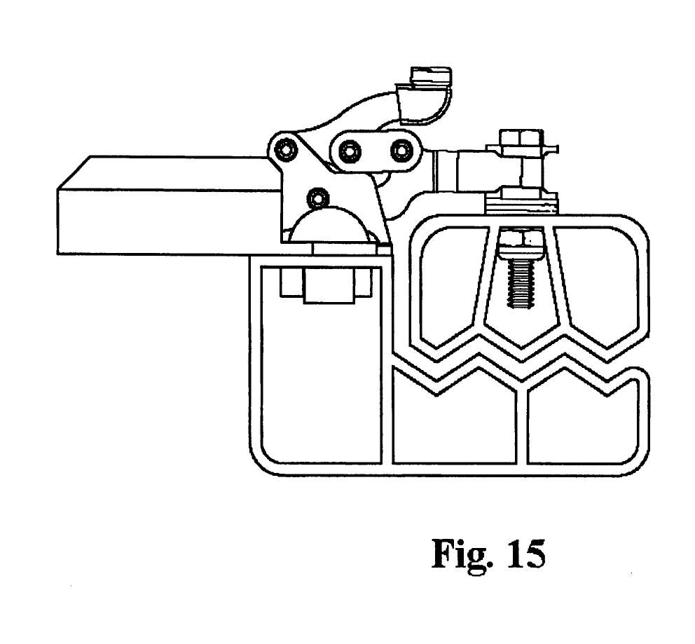

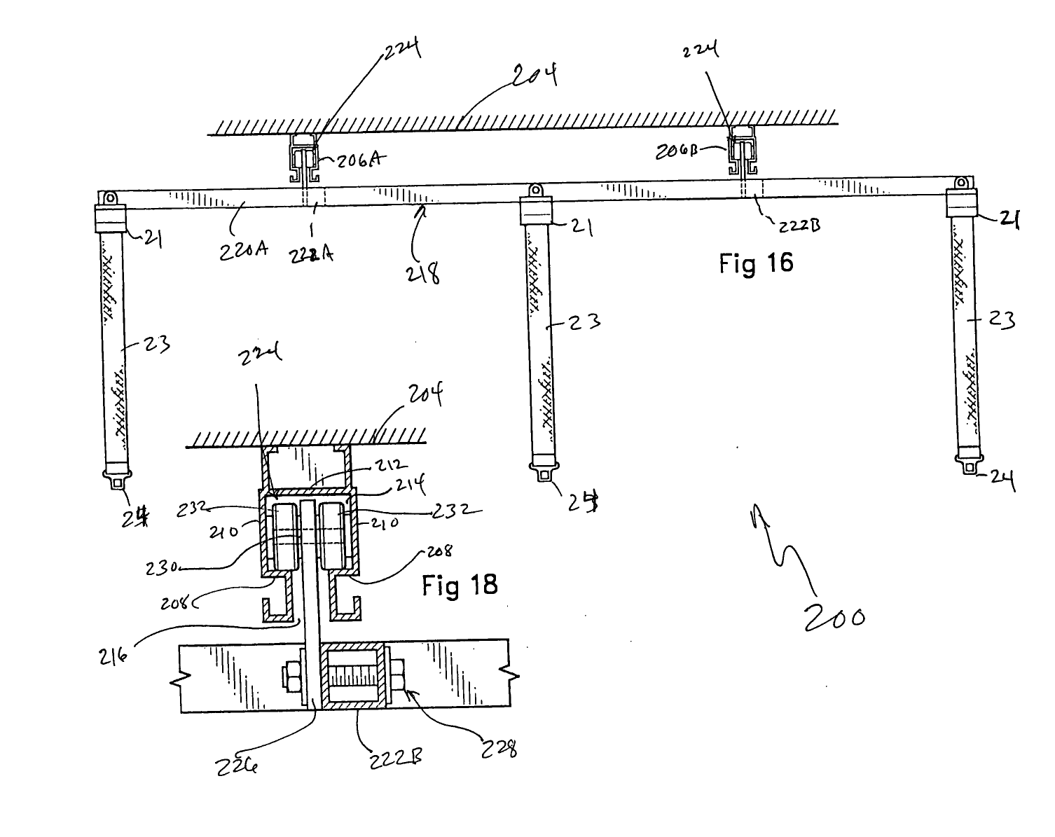

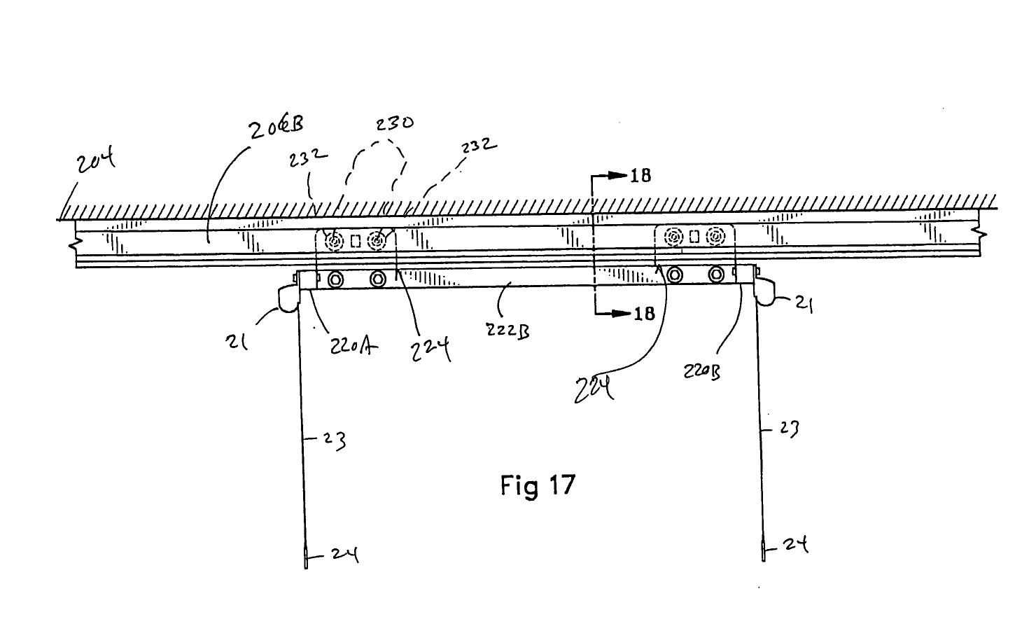

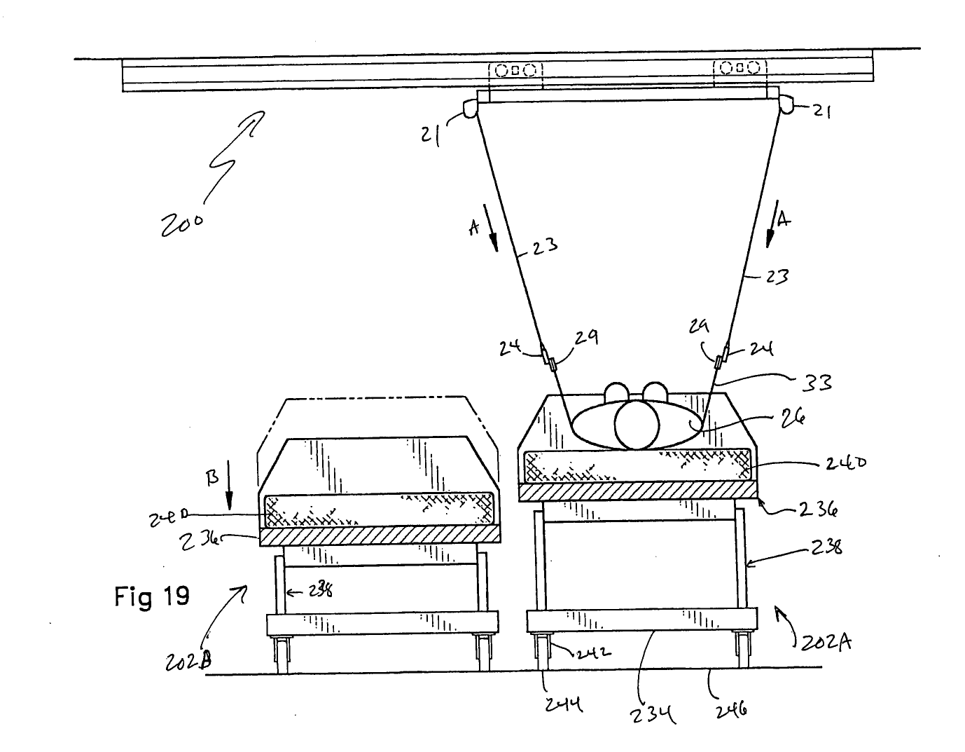

Another embodiment of the repositioning apparatus of the present invention is shown generally at 200 in FIGS. 16 and 17. Apparatus 200 is configured as an overhead apparatus for use with an adjustable bed 202 (two of which are shown at 202a and 202b in FIG. 19). Apparatus 200 is configured to be secured to and extend downwardly from a ceiling to a floor or other overhead support. Apparatus 200 includes a pair of spaced parallel rigid rails 206A and 206B which are secured to ceiling 204 by any suitable mechanism known in the art. Rails 206 are thus substantially parallel to ceiling 204 and extend downwardly therefrom. Each rail 206 is configured with a pair of spaced horizontal walls or tracks 208 having upwardly facing support surfaces. A pair of spaced sidewalls 210 are rigidly secured respectively to walls 208 and extend upwardly therefrom to a rigid connection with a horizontal top wall 212 whereby wall 208, 210 and 212 define therewithin a horizontally elongated passage 214 which opens downwardly at a bottom entrance opening 216.

Apparatus 200 further includes a rigid generally rectangular frame 218 which includes a pair of spaced parallel support beams 220a and 220b which run perpendicular to rails 206. Frame 218 further includes a pair of spaced parallel crossbars 220A and B which are parallel to rails 206 and perpendicular to beams 220. Crossbars 222 extend between and are rigidly connected to beams 220. Apparatus 200 further includes four roller assemblies 224, two of which are secured to and extend upwardly from crossbar 220a adjacent its opposed ends, and two of which likewise are connected and extend upwardly from crossbar 220b adjacent its opposed ends. Each roller assembly 224 includes a mounting member in the form of a mounting plate 226 which is rigidly secured to one of crossbars 222 via nut and bolt fasteners 228 or the like. A pair of axles 230 is secured to each plate 226 and extends outwardly in opposite direction therefrom for rotatably mounting thereon the pair of rollers 232 on either side of plate 226. Rollers 232 are received within passage 214 along with axles 238 and an upper portion of plate 226 so that rollers 232 rollingly engage the upper surfaces of tracks 208 to roll there along back and forth. In the exemplary embodiment, the rolling movement of frame 218 via roller assemblies 224 is done manually and thus preferably without the use of motors to minimize costs. As in the earlier embodiments, belt retraction assemblies 21 are provided, three of which are secured to each beam 220 with a pair of assemblies 21 adjacent opposed ends of beam 220 and one centrally located therebetween. Strap 23 with inserting buckles 24 on their lower ends are also provided as discussed in the previous embodiments so that straps 23 may be retracted within or extended from the housing of each assembly 21 via a process of coiling and uncoiling or rolling and unrolling of strap 23 on the retraction mechanism.

One aspect of the operation of apparatus 200 is described shortly hereafter with reference to FIGS. 19-22. Before describing the operation of apparatus 200, beds 202 are described in greater detail. Each bed 202 is an adjustable bed such as is commonly used in hospitals and so forth. Each bed 202 includes a rigid lower frame 234, and a rigid upper frame 236 and lift assembly 238 which is mounted on lower frame 234 and extends upwardly to support upper frame 236. Lift assembly 238 may be any lift known in the art and is used for raising and lowering upper frame 236 relative to lower frame 234. A bed mattress 240 is seated atop and supported by upper frame 236 and thus is raised and lowered with upper frame 236 when lift assembly 238 is operated. Each bed 202 typically also includes a plurality of wheel assemblies each including a wheel mount 242 secured to and extending downwardly from lower frame 234 and respective wheels 244 which are rotatably mounted on wheel mounts 242 so that bed 202 may be rolled about as desired on a floor 246.

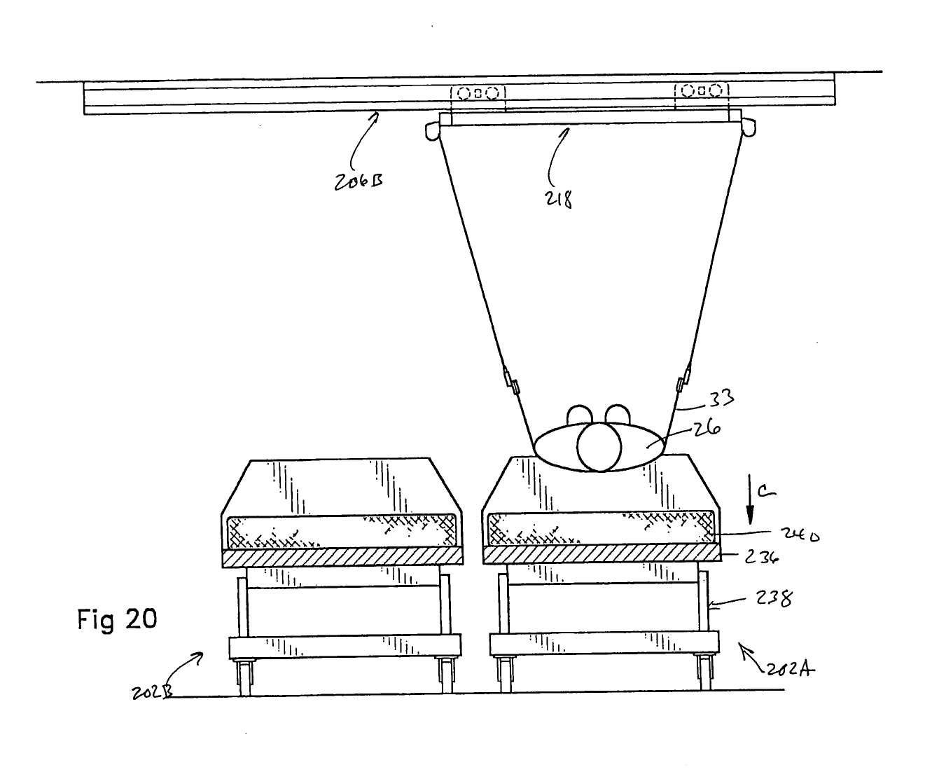

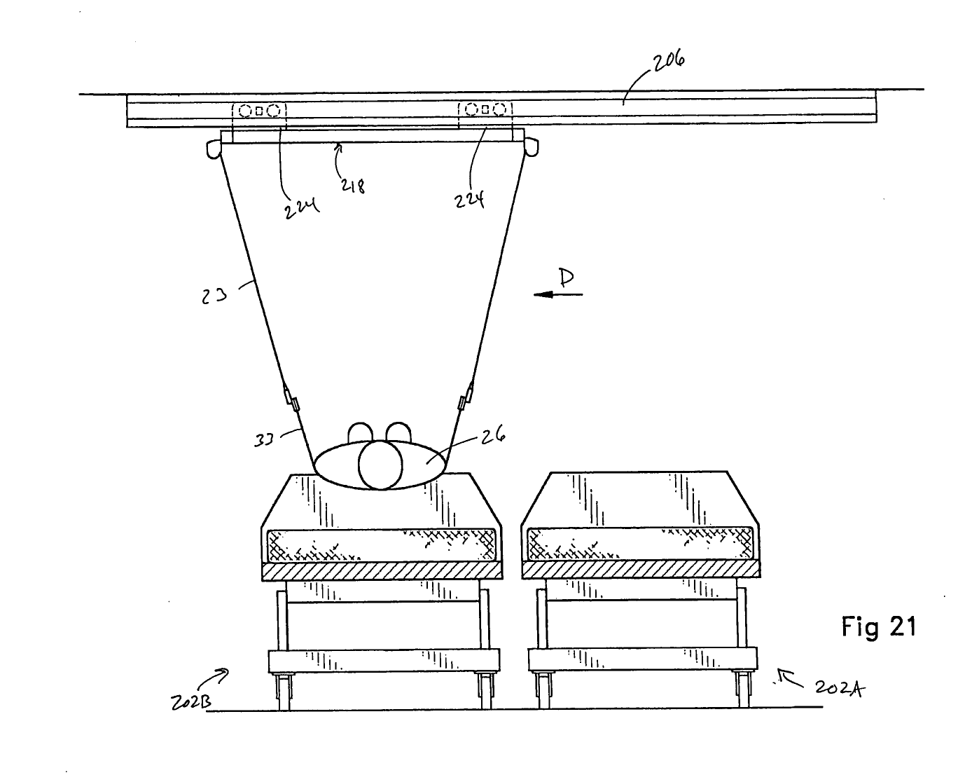

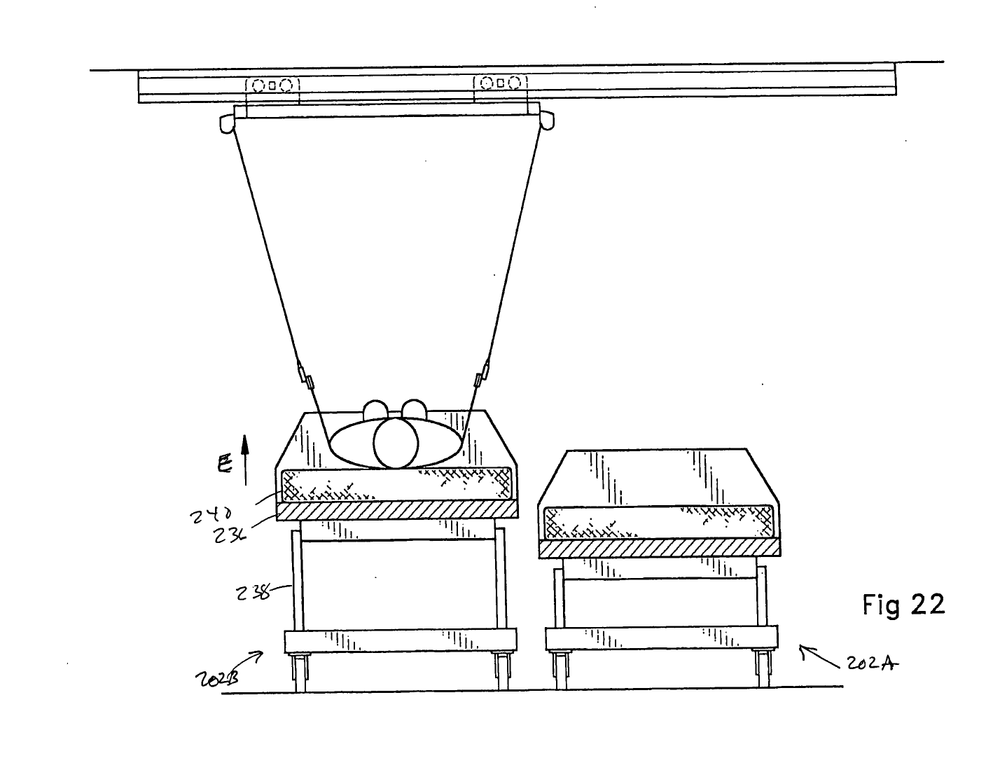

As shown in FIG. 19, straps 23 have been extended (arrow A) from within retraction mechanism 21 so that inserting buckles 24 are received within receiving buckles 29 to form a connection between straps 23 and support sheet 33 on both sides thereof. Support sheet 33 thus forms a sling for supporting patient 26. As shown in FIG. 19, patient 26 is lying on support sheet 33, which is disposed also atop mattress 240 of bed 202a. Bed 202b has been rolled into position adjacent bed 202a so that the beds are side by side. In addition, lift 238 of bed 202b is then operated to lower upper frame 236 and mattress 240 (arrow B) from the position shown in dot dash lines to the position shown in solid lines. FIG. 20 shows that lift 238 of bed 202a is then operated to lower (arrow C) upper frame 236 and mattress 240 out from under patient 26 and support sheet 33 so that patient 26 is entirely suspended by the suspension assembly of apparatus 200. FIG. 21 shows that patient 26 is transferred along a horizontal path from a position above bed 202a to a position above 202b via the rolling of rollers 232 along tracks 208 of rails 206, as indicated at arrow D. This is most preferably done by a manual force applied, also represented by arrow D, wherein said force may be applied by the health care worker or other person most typically directly on patient 26 or any of the suspension assembly of apparatus 200 including support sheet 33, straps 23, the carriage which is formed by frame 218 and roller assembly 224 and so forth. As shown in FIG. 22, once patient 26 is positioned over bed 202b, its lift 238 is operated to raise upper frame 236 and mattress 240 (arrow B) so that mattress 240 contacts support sheet 33 and patient 26 from below to support patient 26 and provide slack to the straps 23, which may then be disconnected via buckles 24 and 29 as described with reference to the previous embodiment.

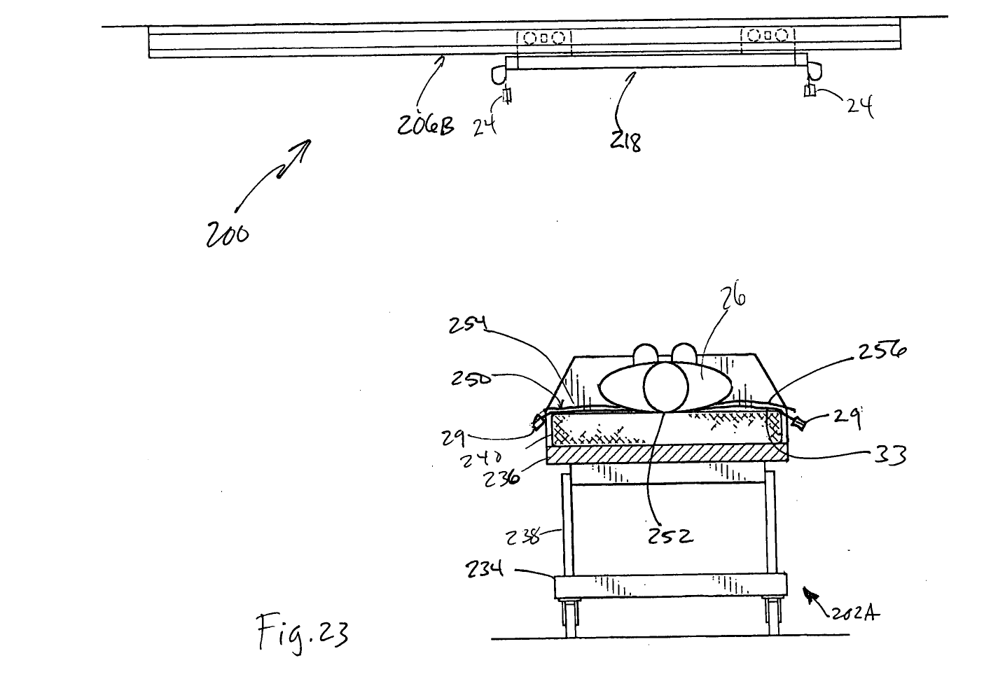

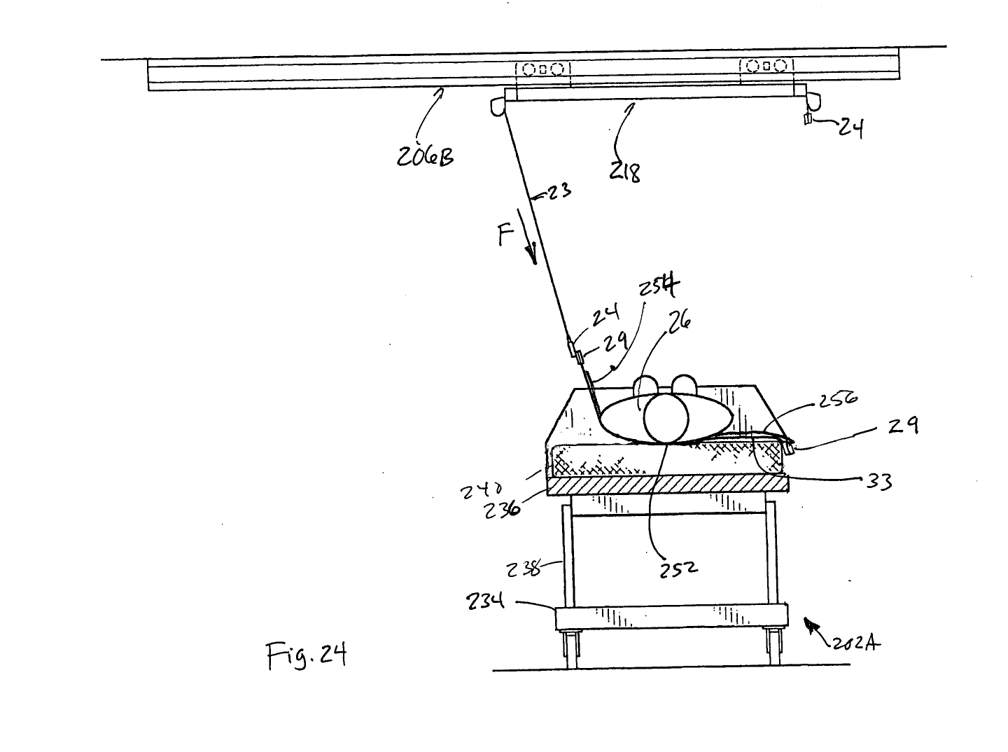

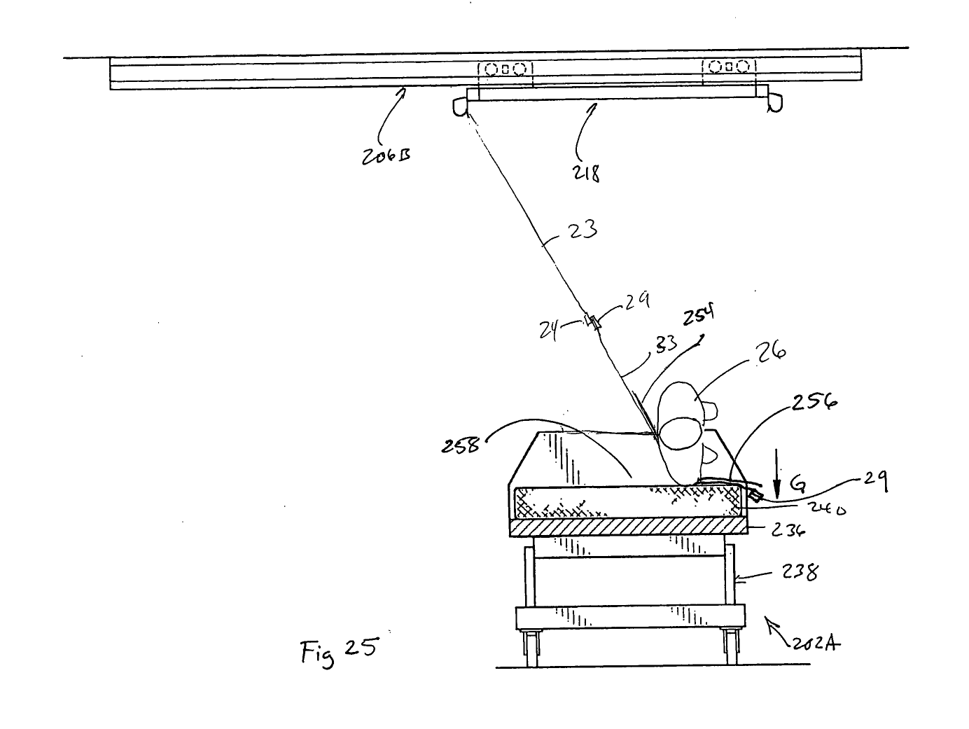

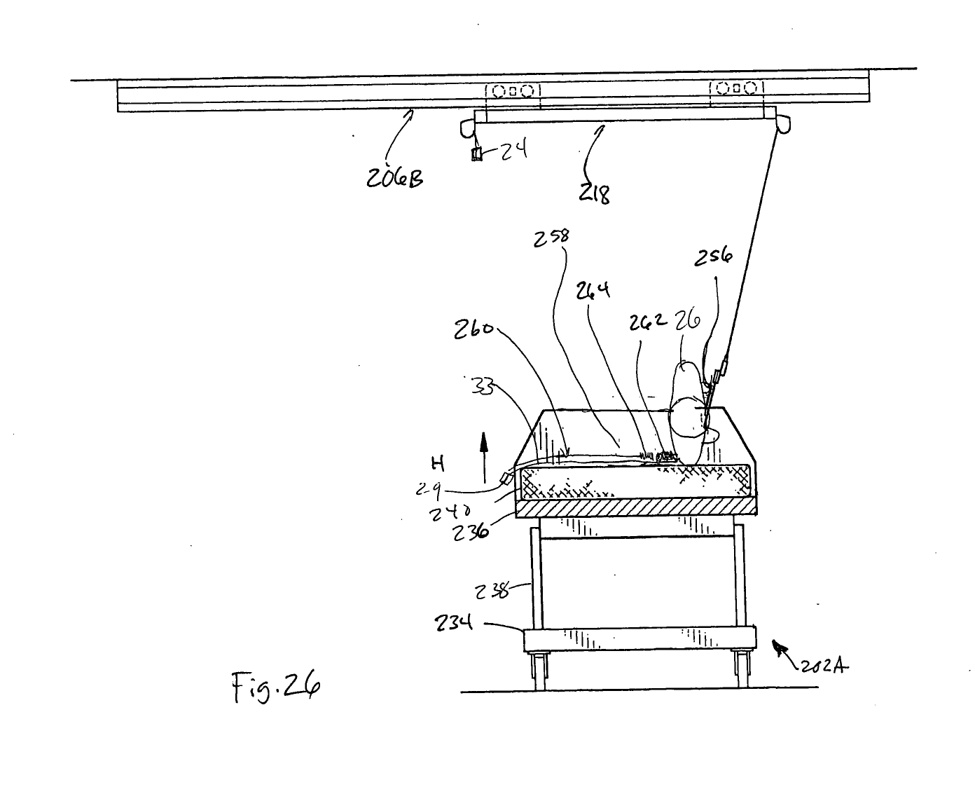

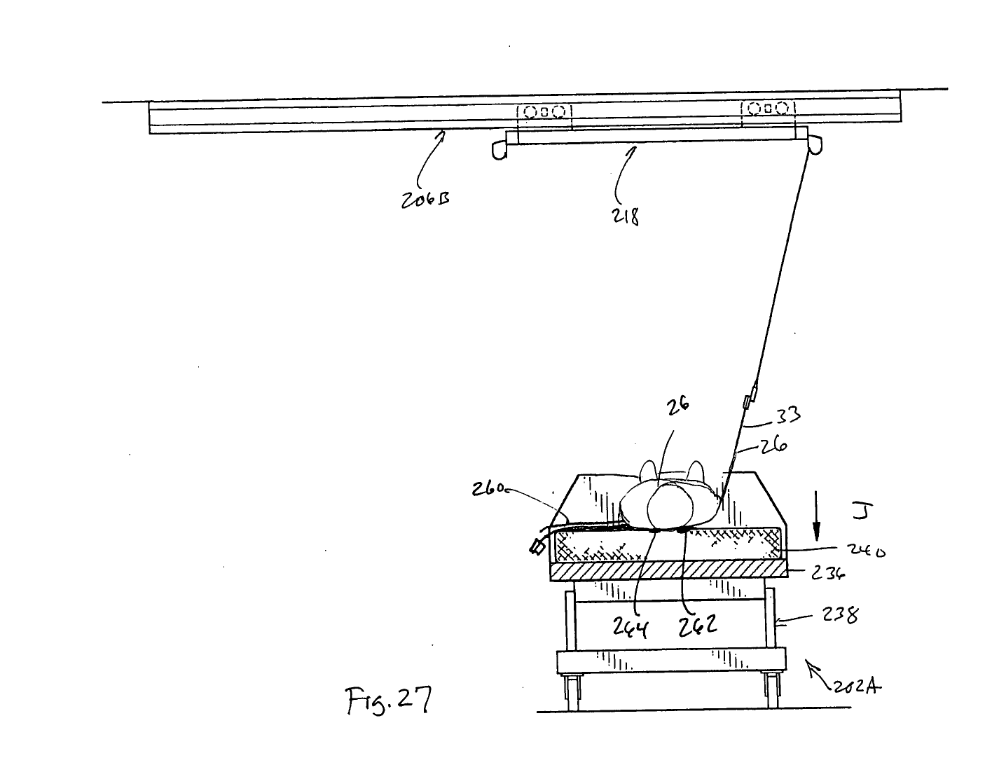

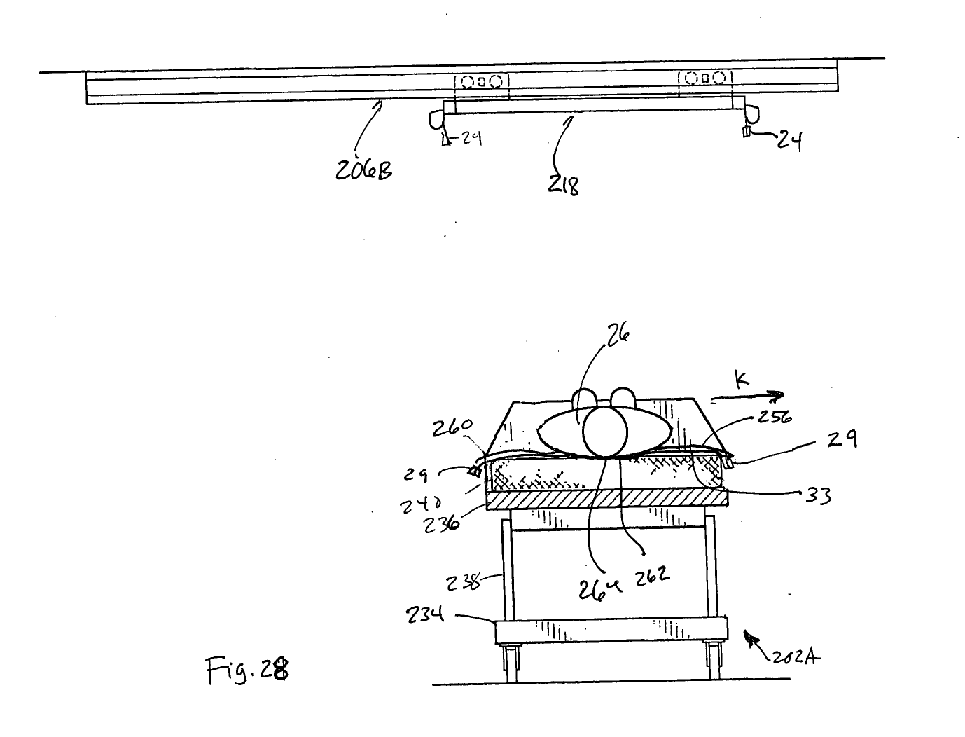

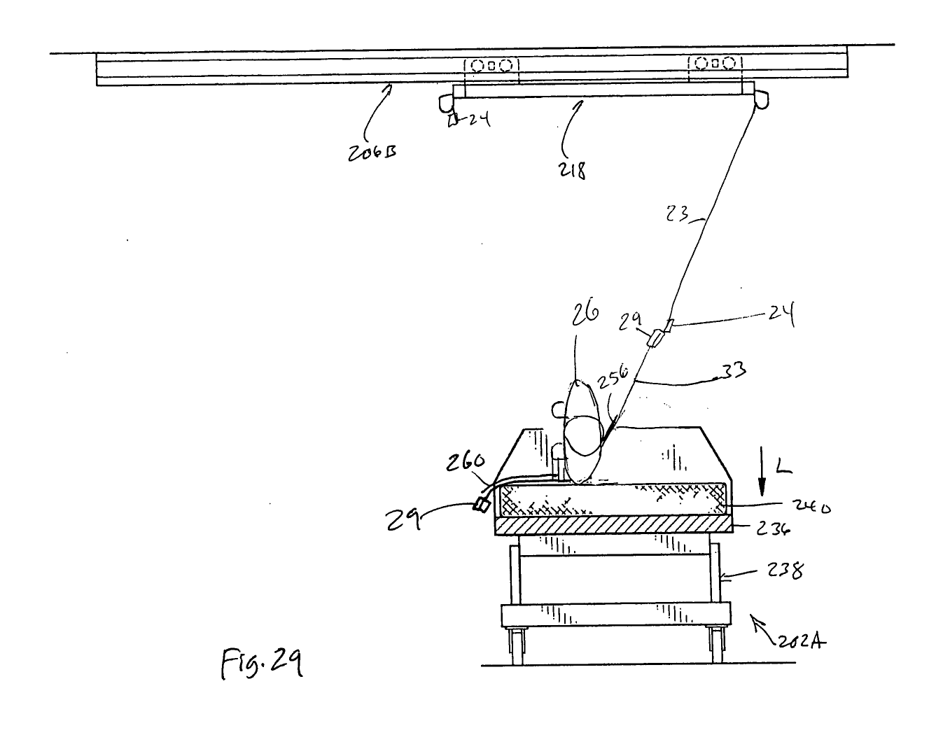

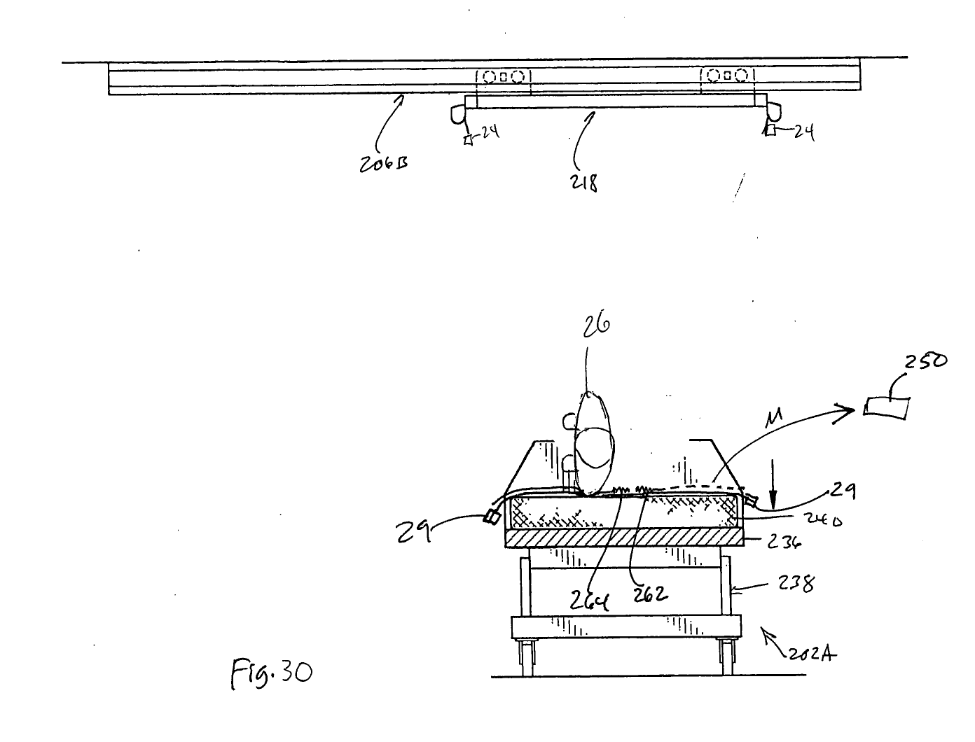

Another operation of the present invention is shown with references to FIGS. 23-30. FIG. 23 shows patient 26 lying on bed 202A with sheet support 33 atop mattress 240 and a soiled sheet 250 atop sheet support 33 so that a first section 252 is disposed directly beneath patient 26, a second section 254 extends outwardly from section 252 on one side of patient 26, and a third section 256 extends outwardly from section 252 on the other side of patient 26. FIG. 24 shows straps 23 on one side of patient 26 extended (Arrow F) so that buckle 24 is connected to buckle 29. FIG. 25 shows the lowering of upper frame 236 and mattress 240 (Arrow G) so the patient 26 is automatically rolled to the right side of the figure onto section 256 of sheet 250 so as to open a space 258 above mattress 240 which patient 26 formerly occupied when lying on his or her back. FIG. 26 shows mattress 240 and upper frame 236 being raised (Arrow H) so that support sheet 33 is laid back along the top of mattress 240 while patient 26 remains on his right side. Section 254 of soiled sheet 250 is then bundled or otherwise moved within space 258 adjacent the back of patient 26 to form a bundle 262. A new sheet 260 is laid atop the exposed sheet support 33 with a bundled portion 264 thereof within space 258 adjacent bundled portion 262. FIG. 27 shows the lowering of the bed (Arrow J) in order to roll patient 26 back onto his or her back atop bundled portions 262 and 264. FIG. 28 shows the uncoupling of buckles 24 and 29 on the right side of patient 26 and the optional removal of the new and old sheets from the right side from underneath patient 26 as indicated at Arrow K. However, in certain scenarios the removal of the old sheet and spreading of the new sheet may be difficult. Thus, as shown in FIG. 29, buckles 24 and 29 on the right side of patient 26 may be coupled once again and the bed lowered as shown at Arrow L in order to turn patient 26 from his or her back onto his or her left side and onto an additional portion of new sheet 260. FIG. 30 then shows that the buckles 24 and 29 on the right side are uncoupled and laid down so that portions 262 and 264 are exposed whereby the old sheet 250 may be removed as shown at Arrow M and the new sheet may be spread onto the rest of mattress 240.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. A method comprising the steps of:
suspending from an overhead suspension member a patient support which is atop a bed and beneath a patient on the bed;
lowering the bed relative to the suspension member.

2. A method comprising the steps of:
suspending from an overhead suspension member a patient support which is atop a bed and beneath a first bed linen which is atop the bed and on top of which a patient is supported;
moving one of the bed and suspension member relative to the other to increase the vertical distance therebetween.

3. The method of claim 2 wherein the patient in a first position is lying on his or her back so that the first bed linen comprises a first non-exposed section beneath the patient, a second exposed section extending outwardly from the first section to a first side of the patient and a third exposed section extending outwardly from the first section to a second opposed side of the patient; and the method further comprises the steps of:
coupling the suspension member and the patient support along the second side of the patient;
turning the patient, as a result of the step of moving to increase the vertical distance, from the first position to a second position in which the patient is lying on his or her first side on the second section of the first bed linen and to open a space which the patient occupied in the first position;
placing the third section of the first bed linen into the space atop the patient support.

4. A patient positioning apparatus comprising:
an overhead support;
a frame;
a roller rotatably mounted on one of the overhead support and the frame;
a plurality of suspension members extending downwardly from the frame;
a patient support;
a connection mechanism for connecting the suspension members to the patient support.
